(19) United States
(12) Patent Application Publication
(10) Pub. No.: US 2025/0211005 A1
(43) Pub. Date: Jun. 26, 2025

(54) Mobile Device Stand

(71) Applicant: Kyle Hayes, Coppell, TX (US)

(72) Inventor: Kyle Hayes, Coppell, TX (US)

(21) Appl. No.: 18/395,285

(22) Filed: Dec. 22, 2023

(51) Int. Cl. H02J 7/00; G09F 23/00; H02J 50/00; H02J 50/10

(52) U.S. Cl. CPC H02J 7/0044; H02J 50/005; H02J 50/10; G09F 23/00; H02J 2207/30

(57) ABSTRACT

A stand for a mobile device comprises a base and a housing. The base is configured to be affixed to a surface, and comprises a plate and a stop guide. The housing is configured to couple to the base. The housing defines a cavity, a receptacle configured to receive a wireless charging device, a recess configured to receive a portion of a cable of the wireless charging device, and a slot configured to receive the stop guide. The housing is movable relative to the base from a first position to a second position, whereby, when the housing is in the first position the stop guide is in a first portion of the slot, and when the housing is in the second position the stop guide is in a second portion of the slot.

### TECHNICAL FIELD

This disclosure relates to mobile devices, and in particular to a stand for a mobile device.

### BACKGROUND

Mobile device stands are accessories designed to provide a stable and convenient platform for smartphones and tablets. These stands come in various forms, ranging from simple, portable holders to more intricate adjustable mounts. They play a crucial role in enhancing user experience by allowing hands-free operation, making activities such as video calls, watching videos, or reading content more comfortable.

### SUMMARY

This disclosure provides a mobile device stand that comprises a base and a housing. The base is configured to be affixed to a surface, and comprises a plate and a stop guide. The housing is configured to couple to the base. The housing defines a cavity, a receptacle configured to receive a wireless charging device, a recess configured to receive a portion of a cable of the wireless charging device, and a slot configured to receive the stop guide. The housing is movable relative to the base from a first position to a second position, whereby, when the housing is in the first position the stop guide is in a first portion of the slot, and when the housing is in the second position the stop guide is in a second portion of the slot:

In aspects, the housing defines a first fastener opening and the base defines a second fastener opening, the first and second fastener openings coaxial with each other when the housing is coupled to the base. In aspects, the first and second fastener openings may be configured to receive a fastener to secure the housing and the base to the surface.

The stand for a mobile device of claim 1, the base may define a cable opening, wherein, when the housing is coupled to the base, the cable opening overlaps with the slot to permit the cable to pass therethrough.

In other aspects, the cable opening may be adjacent the stop guide, such that, when the housing is rotated relative to the base, the stop guide inhibits the housing from reducing the cable opening.

In some aspects, the receptacle may be open from a top of the housing, such that a mobile charging device received by the receptacle forms a top surface of the housing.

In additional aspects, the housing further may define a top surface, wherein the receptacle is underneath the top surface.

In aspects, a thickness of the top surface may be about 3 millimeters or less.

In more aspects, the top surface may be configured to display an advertisement.

In some further aspects, The housing may further define a cable opening.

In another embodiment of this disclosure, a stand for a mobile device comprises a base; a housing rotatably coupled to the base; and a stop guide. The housing defines a receptacle configured to receive a wireless charging device and a slot. The stop guide protrudes from the base into the slot and is configured to inhibit rotation of the housing relative to the base at a first end of the slot and a second end of the slot.

In aspects, the base may include a first coupler and the housing may include a second coupler, the first and second couplers configured to cooperatively, rotatably secure the housing to the base.

In more aspects, the housing may define a top surface configured to display an advertisement.

In other aspects, the top surface defines a retainer configured to receive a removable display sheet configured to display the advertisement.

In aspects, the base may define a cable opening, wherein, when the housing is coupled to the base, the cable opening overlaps with the slot to permit a cable to pass therethrough.

In additional aspects, the housing may define a cable recess configured to receive a portion of a cable proximate the wireless charging device when the wireless charging device is received by the receptacle.

In yet other aspects, a top of the housing defines an angle between 1 degrees and 30 degrees relative to the base.

In further aspects, the housing may also comprise a housing top half defining the receptacle and a housing bottom half defining the slot. The housing top half and the housing bottom half are configured to be fixed to each other to inhibit separation of the housing top half and the housing bottom half.

In aspects, the slot may define an arc less than 181°, whereby the stop guide and the slot cooperatively confine rotation of the housing relative to the base to the degree of the arc.

In some aspects, the base is configured to be secured to a surface by at least one of an adhesive, a suction pad, hook and loop fastener, a magnet, or a fastener.

This disclosure also provides a mobile device stand comprising a base, a housing configured to receive a wireless device charger, the housing rotatable relative to the base, and a stop guide adapted to restrict rotation of the housing relative to the base.

### BRIEF DESCRIPTION OF THE DRAWINGS

The accompanying drawings, which are incorporated in and constitute a part of this specification, illustrate aspects and features of the disclosure and, together with the detailed description below, serve to further explain the disclosure, in which:

FIG. 1 illustrates a parametric view of a mobile device stand in accordance with a first embodiment of this disclosure;

FIG. 2 is a bottom view of a housing of the mobile device stand shown in FIG. 1, in accordance aspects of this disclosure;

FIG. 3 is a top view of a base of the mobile device stand shown in FIG. 1, in accordance with aspects of this disclosure;

FIG. 4 shows a top-parametric view of the mobile device stand, in accordance with aspects of this disclosure;

FIG. 5 illustrates a parametric view of another housing for a mobile devise stand, in accordance with further embodiments of this disclosure;

FIG. 6 is a bottom view of a housing top-half of the housing shown in FIG. 5, in accordance with aspects of this disclosure;

FIG. 7 is a cross-sectional bottom view of the housing top-half shown in FIG. 5, taken along perspective A-A shown in FIG. 5, with a mobile device charger disposed therein, in accordance with aspects of this disclosure;

FIG. 8 is a top view of a housing bottom-half show in FIG. 5, in accordance with aspects of this disclosure;

FIG. 9 illustrates an exploded side view of another mobile device stand, in accordance with embodiments of this disclosure;

FIG. 10 shows a top view of housing bottom half of a housing shown in FIG. 9, in accordance with aspects of this disclosure;

FIG. 11 shows a parametric, back view of the housing top-half shown in FIG. 9, in accordance with aspects of this disclosure;

FIG. 12 is a top view of another housing of a mobile device stand, in accordance with embodiments of this disclosure

FIG. 13 is a side view of the housing shown in FIG. 12, in accordance with aspects of this disclosure.

Further details and various aspects of the disclosure are described in more detail below with reference to the appended figures.

### DETAILED DESCRIPTION

Aspects of the presently disclosed mobile device stand are described in detail with reference to the drawings in which like reference numerals designate identical or corresponding or similar elements in each of the several views. However, it is to be understood that the disclosed devices are merely exemplary of the disclosure and may be embodied in various forms. Well-known functions or constructions are not described in detail to avoid obscuring the disclosure in unnecessary detail. Therefore, specific structural and functional details disclosed herein are not to be interpreted as limiting, but merely as a basis for the claims and as a representative basis for teaching one skilled in the art to variously employ the disclosure in virtually any appropriately detailed structure.

Terms including “generally,” “about,” “substantially,” “approximately,” and the like, as utilized herein, are meant to encompass variations, e.g., manufacturing tolerances, material tolerances, use and environmental tolerances, measurement variations, and/or other variations, up to and including plus or minus 10 percent.

This disclosure provides a mobile device stand that enables users to enjoy the user's mobile device hands-free while also charging their mobile device using a mobile device charger. Mobile devices may recharge their battery either through a hard wire connection (e.g., such as through USB-C charging cables) or inductively using a wireless device charger (e.g., like a Qi wireless charging device). Wireless device chargers magnetically couple to a mobile device when charging the mobile device, and thus exert a magnetic force on the mobile device. The mobile device stand provided by this disclosure enables the mobile device to be separated from a wireless device charger without the mobile device carrying the mobile device stand. In other words, this disclosure recognizes that a force greater than the magnetic force between the mobile device and the wireless device charger must be overcome to separate each other. The mobile device stand described herein is securable to a surface such that the mobile device stand does not move relative to the table as a user lifts a mobile device that is magnetically coupled to the mobile device stand via the wireless device charger disposed in the mobile device stand. The device stand provided herein provides the additional benefit of protecting the wireless device charger, as will be described in detail below.

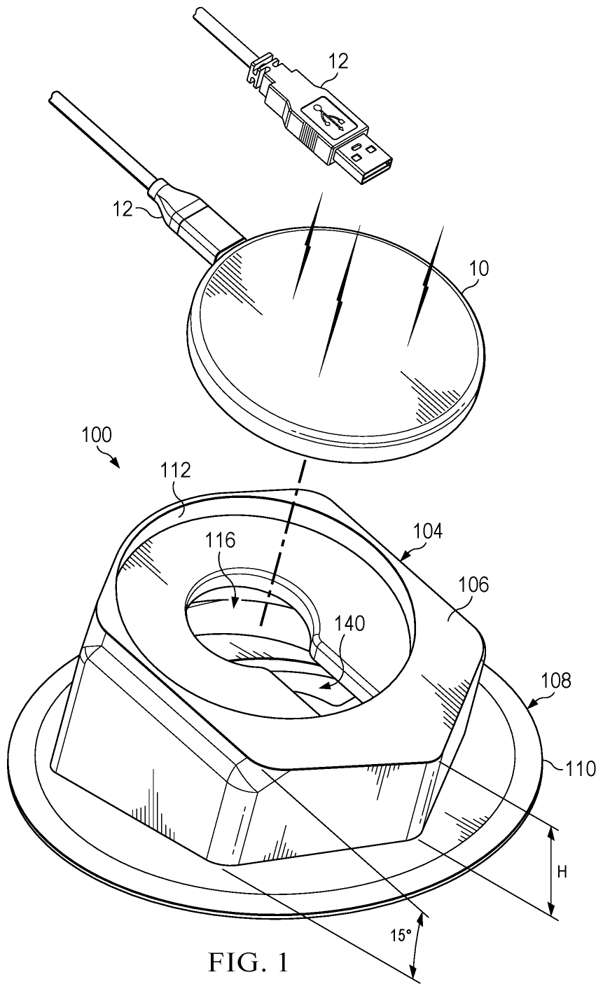

With reference to FIG. 1, a mobile device stand 100 includes a housing 104 and a base 108. The housing 104 is rotatably coupled to the base 108. The housing 104 defines a receptacle 112 and a cavity 116. The receptacle 112 is configured to receive a wireless device charger 10. The receptacle 112 may secure the wireless device charger 10 via friction fit. For example, for a circular wireless device charger 10 the receptacle 112 may have a diameter that is equal to or slightly smaller than the diameter of the wireless device charger 10. The cavity 116 is configured to receive a portion of a cable 12 of the wireless device charger 10. The housing 104 may also define a recess 140 configured to receive a portion of a cable 12 of the wireless device charger 10 that is proximate the wireless device charger 10. While a circular receptacle 112 is shown, the receptacle 112 may be of any shape configured to receive a similarly shaped wireless device charger.

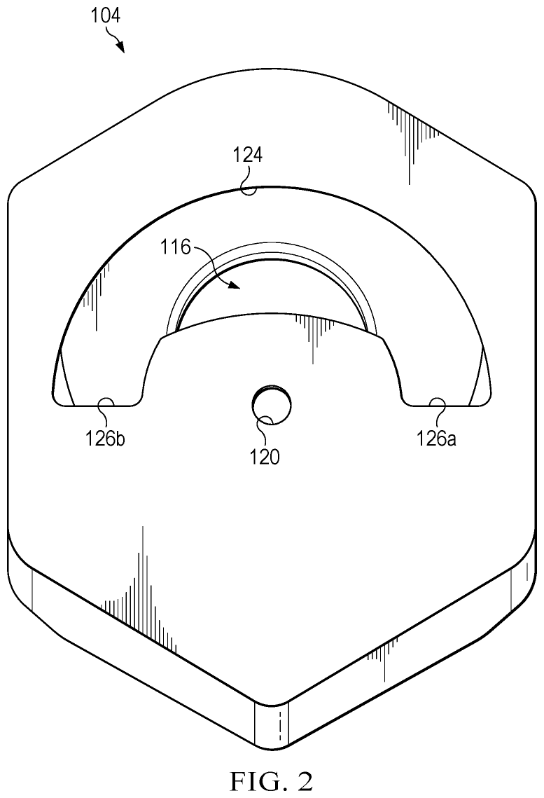

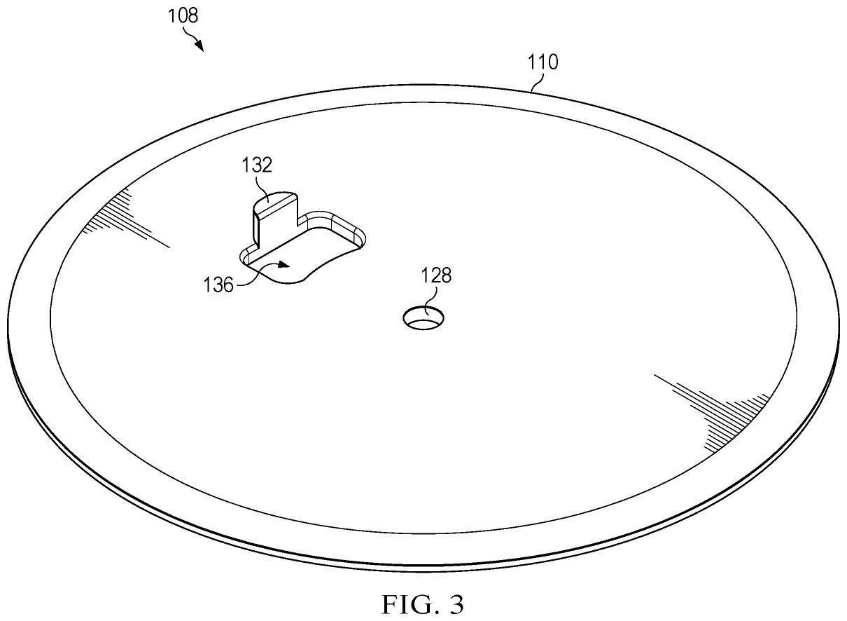

With additional reference to FIGS. 2 and 3, the housing 104 further defines a first fastener opening 120 and a slot 124. The slot 124 includes a first end 126a and a second end 126b. The base 108 includes a stop guide 132. The base 108 also defines a second fastener opening 128 and a cable opening 136.

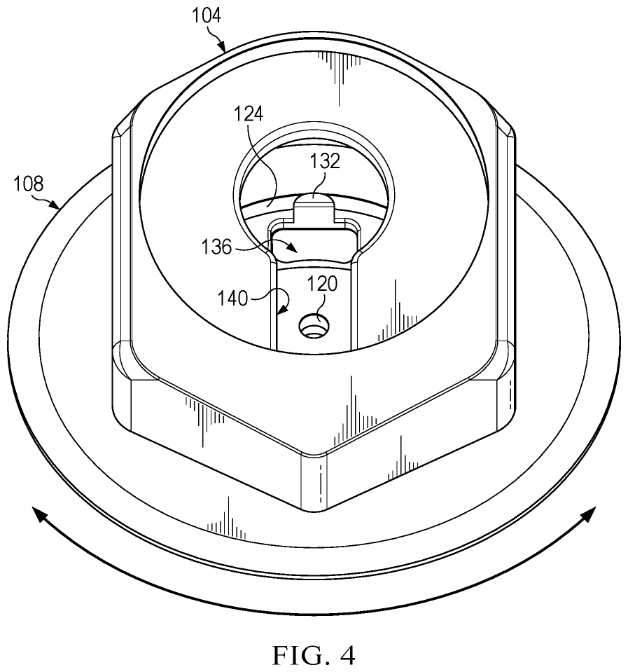

With additional reference to FIG. 4, the housing 104 is rotatably coupled to the base 108. The housing 104 is coupled to the base 108 such that the first fastener opening 120 and the second fastener opening 128 are concentric or coaxial. A fastener, not shown, is inserted through the first and second fastener openings 120, 128, to secure the housing 104 to the base 108 and the base 108 to an approximately flat surface (e.g., a table, a desk, etc. not shown). In aspects, the housing 104 and the base 108 may be coupled by any structure configured to enable rotation of the housing 104 relative to the base 108. The fastener may be a screw or bolt. In aspects, the base 108 may be affixed to a surface by other suitable fasteners, e.g., magnetic fasteners, hook and loop fasteners, a suction cup or a suction pad having a plurality of suction cups, adhesive, tape, etc.

Advantageously, the mobile device stand 100 may thus be removably affixed to the surface, such that, when a mobile device 10 is resting on the mobile device stand 100 and is magnetically coupled to a wireless device charger 10 disposed in the mobile device stand 100, the mobile device stand 100 is pulled from the surface while a user removes the mobile device. In other words, the mobile device stand 100 is thus anchored to a surface such that an equal and opposite force to a wireless device charger's magnetic force is exerted on the mobile device stand 100. This enables a user to pick up the mobile device 20 by only touching, or applying direct force to, the mobile device 20.

The housing 104 rotates about the first and second fastener openings 120 and 128. For example, a fastener, such as a screw, disposed in the first and second fastener openings 120, 128, may provide an axis about which the housing 104 rotates relative to the base 108. In aspects, the fastener might be a pin or rod enabling the housing 104 to rotate relative to the base 108.

When the housing 104 is coupled to the base 108, the stop guide 132 is received by the slot 124. The stop guide 132 is configured to inhibit complete rotation (e.g., about) 360° of the housing 104 relative to the base 108. The slot 124 may be configured to define an arc less than 360°. In aspects, the slot 124 is configured to define an arc that is approximately or less than 180°. As the housing 104 is rotated relative to the base 108 the slot 124 also turns. The housing 104 may thus be rotated until the stop guide 132 reaches either the first end 126A or the second end 126B of the slot 124. The stop guide 132 and the slot 124 thus cooperatively confine rotation of the housing 104 relative to the base 108 to the degree of the arc of the slot 124.

In other words, the housing 104 is movable relative to the base 108. When the housing 104 is in a first position the stop guide 132 is in a first portion of the slot 124, e.g., at first end 126a, and when the housing 104 is in a second position, the stop guide 132 is in a second portion of the slot 124, e.g., second end 126b.

While slot 124 is illustrated using an arcuate structure, slot 124 may be of any shape so as to define a path of the housing 104 relative to the base 108. For example, the slot 124 may be a straight slot to define a linear path of the housing 104 relative to the base 108. In such alternative aspects, the housing 104 and the base 108 may be coupled to each other by means other than a fastener disposed through the first and second fastener openings 120, 128.

The stop guide 132 is disposed adjacent to the cable opening 136. The cable opening 136 is configured to overlap with the slot 124 to permit the cable to pass through the slot 124 and the cable opening 136. For example, a cable 12 of the wireless device charger 10 may be inserted from a top of the housing 104 into the cavity 116 and through the slot 124 and the cable opening 136. When the mobile device stand 10 is affixed to a surface, the cable may then pass through a hole in the surface to be coupled to an electrical source (e.g., a charging block in an electrical outlet).

Advantageously, when the wireless device charger 10 is disposed in the receptacle 112, the slot 124 and the stop guide 132 cooperatively reduce the amount that a cable 12 of the wireless device charger 10 becomes twisted, strained, stressed, or otherwise damaged as the housing 104 is rotated. As the housing 104 is rotated relative to the base 108 the stop guide 132 inhibits the housing 104 from trapping or rubbing against the cable 12 since the slot 124 and the cable opening 136 are overlapping. When the housing 104 is rotated relative to the base 108, the stop guide 132 inhibits the housing 104 from reducing the cable opening 106. In aspects, the stop guide 132 is at least half a width of the cable opening 136. In aspects, stop guide 132 and the cable opening 136 are at least twice a width of the cable 12 to ensure sufficient space to prevent the housing 104 from trapping the cable 12 between the housing 104 and the base 108. When the slot 124 is less than 181° the cable 12 is effectively inhibited from twisting and tangling within the cavity 116.

In aspects, the housing 104 or the base 108 may each be made of rubber, plastic, wood, metal, silicon, alone or in any combination with each other, or any other suitable material known by a person of ordinary skill in the art.

In aspects, a top surface, or housing face 106, of the housing 104 forms an angle of 15° relative to the base 108. In aspects, the angle may be from about 0° to about 60°. At lower angles, e.g., less about 30° or less, a mobile device disposed on the housing face 106 may resist sliding off of the mobile device stand 100.

In aspects, when a wireless device charger 10 is disposed in the receptacle 112, the wireless device charger 10 and the housing face 106 are approximately flush with each other to form an approximately smooth surface.

In aspects, the housing 104 may define a height H of at least half an inch. In aspects, the height H is defined so that a mobile device resting thereon is sufficiently raised from the surface the base 108 is affixed to prevent the mobile device from touching the surface or the base 108.

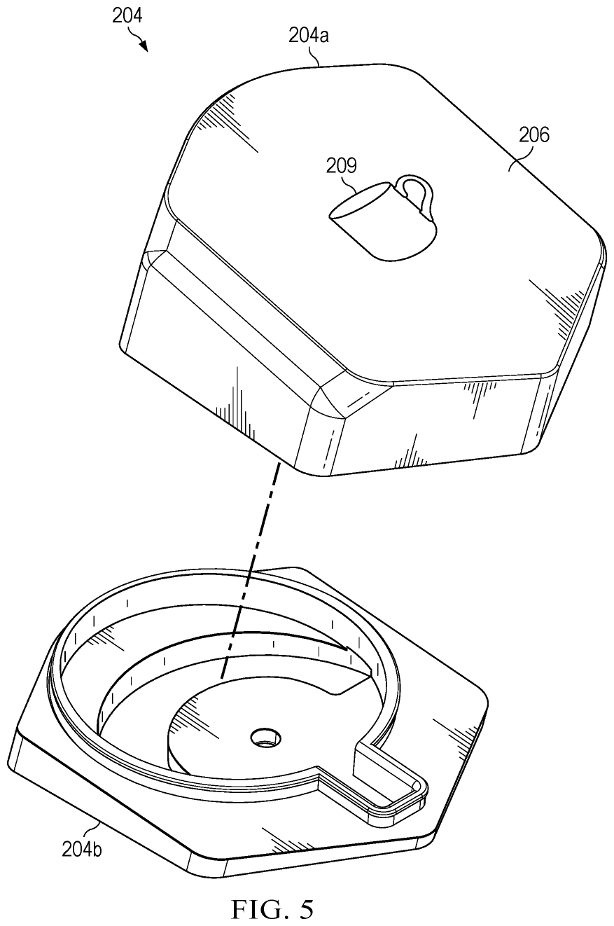

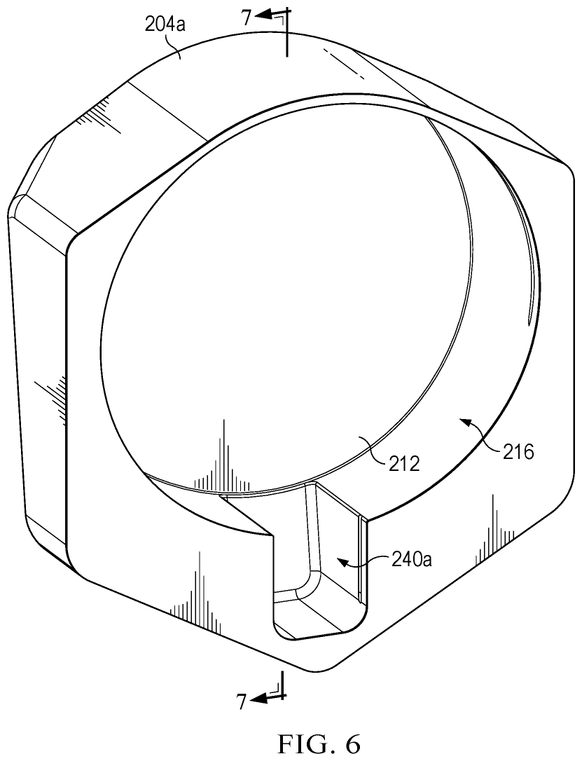

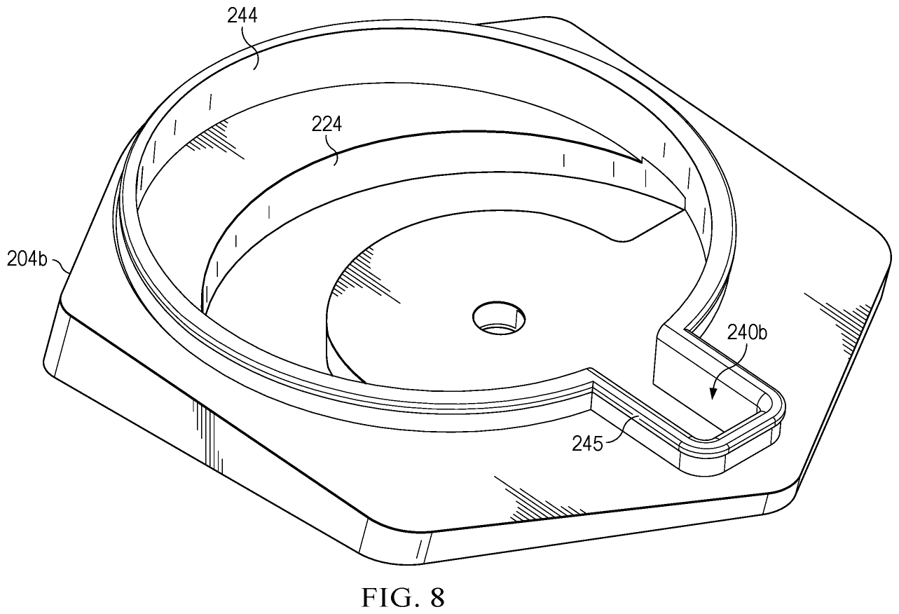

With reference to FIGS. 5-8, another housing 204 for a mobile device stand is shown. The housing 204 may be coupled to the base 108. Housing 204 may be used instead of housing 104 to form a new mobile device stand 200. Aspects of housing 204 that are similar or identical to housing 104 are omitted for brevity, and only the differences between housing 204 and housing 104 are detailed below.

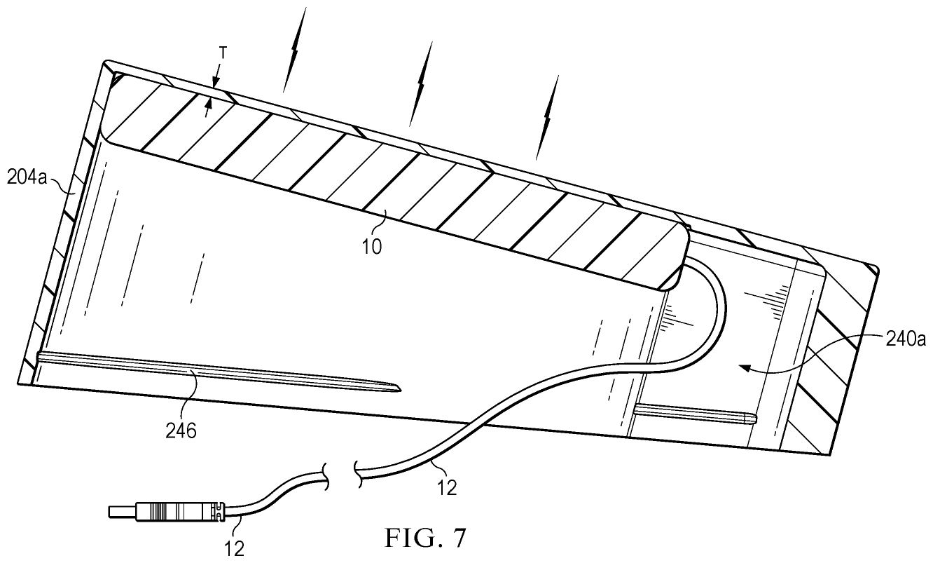

Housing 204 comprises a housing top half 204a and a housing bottom half 204b. Housing top half 204a may be secured by friction fit with housing bottom half 204b. Housing bottom half 204b may include a lip 244 that snaps and locks into a cavity 216 of housing top half 204a. In aspects, a projection 245 of the lip 244 snaps into an indentation 246 (see FIG. 7) inside the cavity 216 of the housing top half 204a, thereby securing the housing bottom half 204b to the housing top half 204a. In aspects, housing top half 204a may be secured to the housing bottom half 204b via a fastener, adhesive, tape, welding, ultrasonic welding, or any other suitable method for mating two parts together. The housing top half 204a is coupled to the housing bottom half 204b after a wireless device charger 10 is inserted into a receptacle to 212 of the housing top half 204a. In some aspects, the housing top half 204a is permanently coupled to the housing bottom half 204b, so as to secure a wireless device charger inside the receptacle 212.

Housing top half 204 a includes a top surface 206 extending over the entire, or a majority, of the housing top half 204a. The receptacle 212 is defined below the top surface 206. As illustrated in the section view in FIG. 7, a wireless device charger 10 may be received by the receptacle 212, such that the wireless device charger 10 is adjacent and abutting the top surface 206. In aspects, the wireless device charger 10 may not be visible from a top of the housing 204. The wireless device charger 10 may be secured within the receptacle 212 by a thin ring extending from the wall of the receptacle 212. The thin ring may inhibit the wireless device charger 10 from falling out of the receptacle 212. In aspects, the housing top half 204a is made of sufficiently pliable material (e.g., rubber, silicon, soft plastics, or the like) to enable a wireless device charger 10 to be pressed into the receptacle 212 adjacent the top surface 206.

The top surface 206 may define a thickness T not greater than three millimeters. The thickness T may not be greater than a distance at which a wireless device charger is capable of wirelessly charging a mobile device.

The housing top half 204a defines a top cable recess to 240a and the housing bottom half 204b defines a bottom cable recess 240b, that together define a cable recess. The cable recess is configured to receive a portion of a cable 12 of a wireless device charger 10 that is inserted into the housing top half 204a as is illustrated in FIG. 7.

The housing bottom half defines the slot 224. Slot 224 may be configured similar to slot 124 and operates similar to slot 124 in conjunction with a stop guide such as stop guide 132 of the base 108.

The housing 204 enables a wireless device charger to be secured inside of a mobile device stand to inhibit easy removal of the wireless device charger. Since the top surface 206 covers at least a majority of a top of the housing top half 204a, the wireless device charger cannot be removed without disassembling the housing top half 204 A and the housing bottom half 204B. This provides some security against the wireless device charger from being removed or stolen. A mobile device stand utilizing the housing 204 the advantageously be used in a public setting without extended concern that a wireless device charger disposed therein will be stolen or damaged.

The top surface 206 is also configured to display an advertisement 209. The advertisement 209 may be painted, drawn, stamped, or engraved onto the top surface 206. In alternative aspects, the advertisement 209 may be a sticker applied to the top surface 206. The advertisement 209 may illustrate, for example, a logo, a QR code, a drawing, a menu, or any other image desired. A mobile device stand utilizing the housing 204 may be affixed to a surface such as a table in a restaurant, an airport, a travel station (e.g., subway or bus station), in a home, school, a stadium, or anywhere else desired, and display a corresponding or related advertisement. Top surface 206 may include any personalized or custom advertisement 209 as imaginable, such as a name, family crest, company emblem, etc.

In some aspects, the housing 204 is cast from plastic or metal, or may be 3D printed. In aspects where the housing 204 is 3D printed, the advertisement 209 may be integrally printed as the housing 204 is formed by the 3D printer. In aspects, the ad 209 may be formed on the top surface 206 as the housing 204 is made.

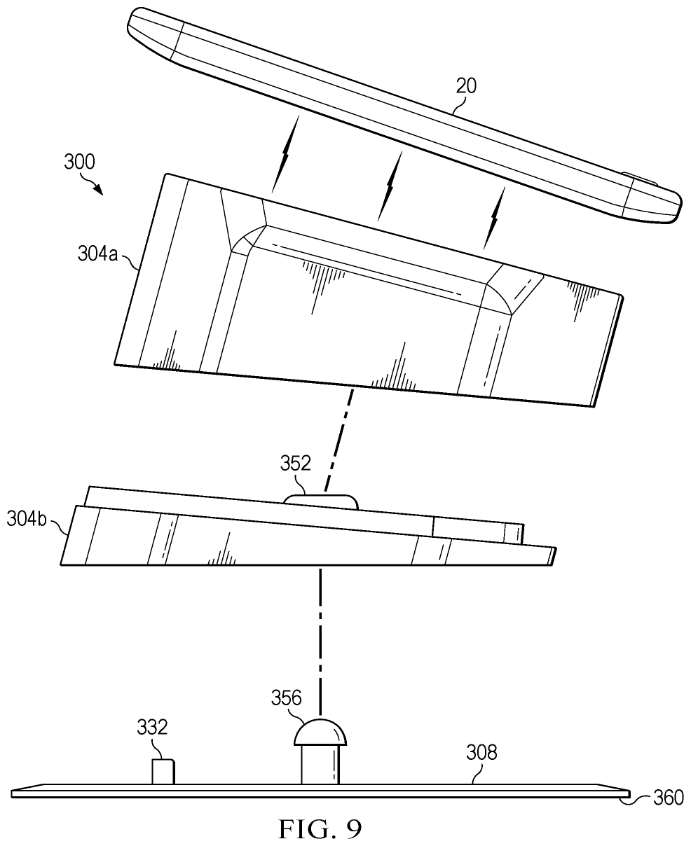

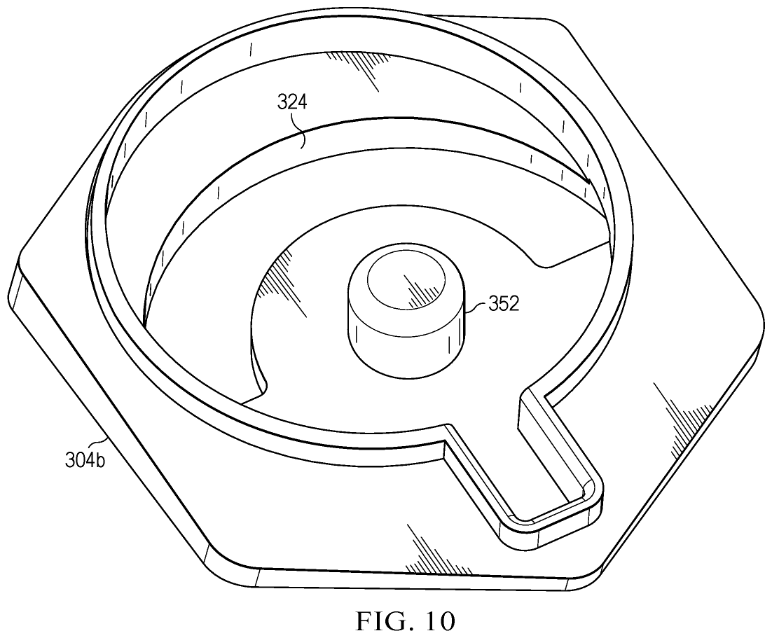

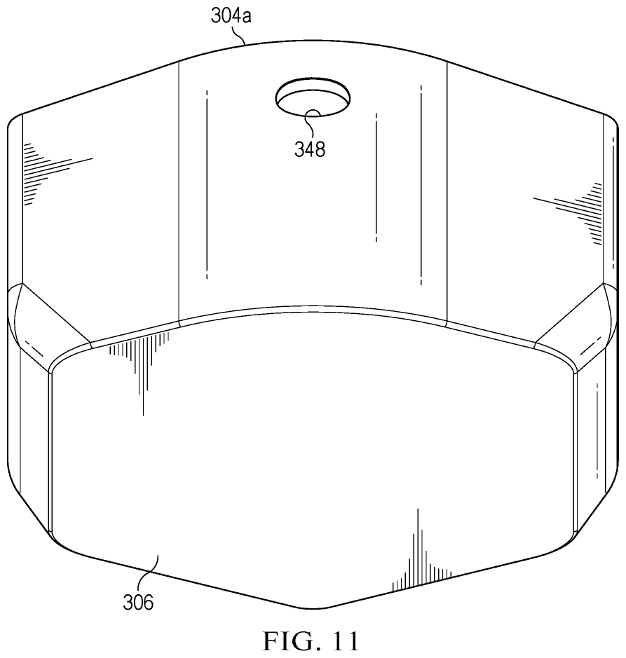

With reference to FIGS. 9-11, a mobile device stand 300 includes a housing top half 304a, a housing bottom half 304b, and a base 308 in accordance with another embodiment of this disclosure. The mobile device stand 300 operates similarly to mobile device 100, features of the housing top half 304a and housing bottom half 304b are similar to those of housing top half 204a and housing bottom half 204b, and base 308 it's similar to base 108. Accordingly, for brevity, only the new different or additional features of mobile device stand 300 are discussed below.

The housing top half 304a may be coupled to the housing bottom half 304b similar to the manners in which the housing top half 204a may be coupled to the housing bottom half 204b. Housing bottom half 304b includes a female coupler 352. The base 308 includes a male coupler 356 that that is inserted into the female coupler 352 to couple the housing top half 304a and housing bottom half 304b to the base 308. Female coupler 352 and the male coupler 356 enable rotation of the housing relative to the base 308. In aspects, the male coupler 356 may include a mushroom cap and the female coupler 352 may include a ledge. When the mushroom cap is inserted into the female coupler 352, the mushroom cap snaps into and above the ledge such that the ledge maintains the mushroom cap in the female coupler 352, thus securely holding the bottom housing half 304b and the base 308 together.

The base 308 may include a bottom surface 360 with a sticky or tacky material to adhere the base 308 to a surface, such as a table or a desk. The bottom surface 360 may include micro suction cups (forming a suction pad), hook and loop fasteners, or reusable adhesive (e.g., a reusable glue or tape), to retain the base 308 on the surface. Mobile device stand 300 may be more easily removed from or repositioned on a surface as compared to mobile device 100 which is secured to a surface by a fastener such as a bolt or a screw. In aspects, a mobile device stand may include the manner of fastening mobile device stand 100 and mobile device stand 300 to a surface.

In aspects, the base 308 may not include a cable opening (e.g., capable opening 136 of base 108). In such aspects, the housing top half 304a may instead define a cable opening 348 to enable a cable 12 to pass through the housing 304. Since the cable opening 348 passes through a side of the housing top half 304a, the cable opening 348 need not overlap with a slot 324 of the housing bottom half 304b. In other aspects, the base 308 does include a cable opening like the cable opening 136 through which the cable 12 may pass through.

In aspects, once housing top half 304a is coupled to housing bottom half 304B they may not be separated without destroying either the housing top 304A or the housing bottom half 304B. In some aspects, once the housing bottom half 304b this coupled to the base 308, they may not be separated without destroying either the housing bottom half 304b or the base 308. In some aspects, the base 308 may include the female coupler 352 and the housing bottom half 304b may include the male coupler 356, wherein a mushroom cap of the male coupler may be configured to be permanently inserted into the female coupler.

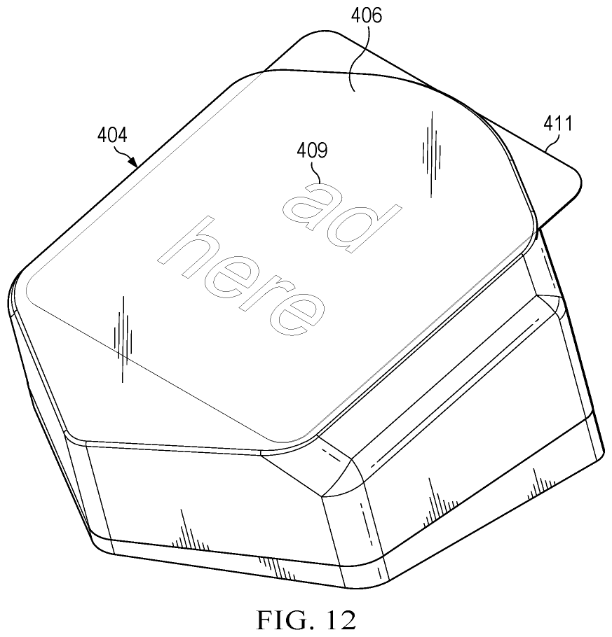

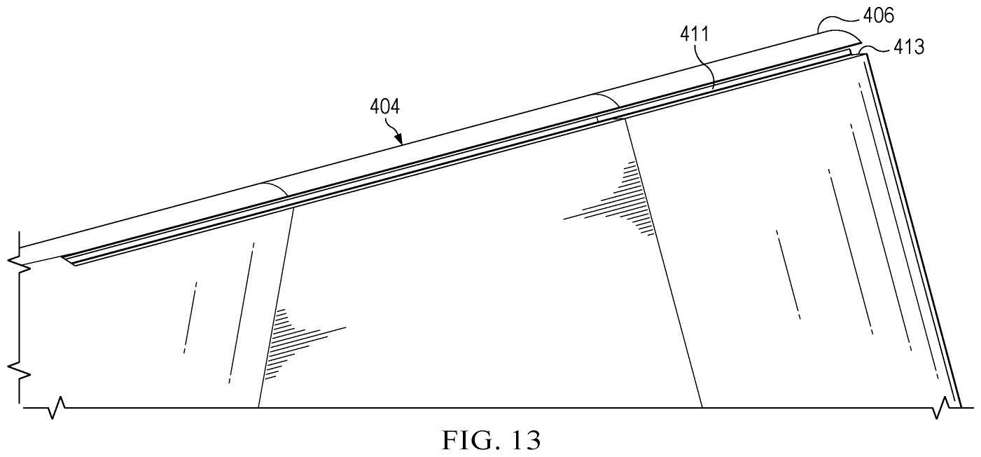

With reference to FIGS. 12 and 13, another mobile device stand may include a housing 404 and a base (e.g., base 108 or base 308). The housing 404 is similar to housing 304, and, therefore, for brevity, only the differences will be detailed below.

The housing 404 includes a top surface 406 displaying an advertisement 409. The top surface 406 of the housing 404 is translucent (e.g., clear or see-through), thereby permitting an advertisement 409 displayed on a removable display sheet or card 411, disposed beneath the top surface 406, to be visible. The top surface 409 may include a thin retainer 413 through which the card 411 may be inserted. In aspects, the card 411 may be inserted approximately fully within the top surface 406 (e.g., as shown in FIG. 13) or the card 411 may project out so as to be easily removed and replaced. The top surface 406 and the card 411 together define a thickness of approximately three millimeters or less to ensure that a wireless charger device 10 is able to charge a wireless device 20 placed on the mobile device stand. In aspects, the thin retainer 413 may be a clip or a small slot through which the card 411 may be held or inserted.

One example use for the housing 404 of a mobile device stand is in a restaurant, airport, travel station, or other public setting. The removable display sheet or card for 11 may display a logo of a business, a menu, a QR code or any other information desirable. The mobile device stands of this disclosure provide the advantage over public hardwire chargers in that data such as malware or viruses cannot be transmitted through the wireless device charger to the wireless device. Further, public hardwire chargers are prone to damage and stress that a wireless device charger in a mobile device stand of this disclosure would not be subjected to (at least to the same degree).

Additionally, the mobile device stands described herein enable two users of a mobile device to easily view the mobile device simply by rotating the mobile device stand. Furthermore, the mobile device stands using housing 204, 304, or 404, reduce the possibility of theft of the wireless device charger disposed in the mobile device stand. In aspects, the mobile device stands of this disclosure may alternatively be used for mobile devices on display for shoppers.

In other aspects of this disclosure, the base 108 may include a thin retainer or clip, and a card 411 may be placed over the receptacle 112 after a wireless device charger is disposed in the receptacle.

In embodiments of this disclosure, a wireless device charger may be manufactured as part of a mobile device stand (e.g., 100, 300). In aspects of such embodiments, the housing does not require a receptacle as the wireless device charger is integrally formed with the housing. In other aspects, the receptacle is defined by a portion of such a mobile device housing the mobile device charger.

The phrases “in an aspect,” “in aspects,” “in various aspects,” “in some aspects,” or “in other aspects” may each refer to one or more of the same or different aspects in accordance with this disclosure. A phrase in the form “A or B” means “(A), (B), or (A and B).” A phrase in the form “at least one of A, B, or C” means “(A); (B); (C); (A and B); (A and C); (B and C); or (A, B, and C).”

Descriptions of technical features of an illustrative mobile device stand described herein may be applicable to other or similar features of another mobile device described herein. Features and advantages of one mobile device stand may be applied to another mobile device stand without departing from the scope of this disclosure and, thus, duplicative descriptions are omitted herein for brevity. By way of example of the manners in which features may be mixed and combined, the base may include the slot and the housing may include the stop guide, without departing from the spirit and character of this disclosure. Since other modifications and changes may be made to fit particular operating requirements and environments, it is to be understood by one skilled in the art that the present disclosure is not limited to the examples described in the present disclosure and may cover various other changes and modifications which do not depart from the spirit or scope of this disclosure.

What is claimed is:

1. A stand for a mobile device comprising:
a base configured to be affixed to a surface, the base comprising a plate and a stop guide;
a housing configured to couple to the base, the housing defining:
a cavity;
a receptacle configured to receive a wireless charging device;
a recess configured to receive a portion of a cable of the wireless charging device; and
a slot configured to receive the stop guide;
wherein the housing is movable relative to the base from a first position to a second position, whereby, when the housing is in the first position the stop guide is in a first portion of the slot, and when the housing is in the second position the stop guide is in a second portion of the slot.

2. The stand for a mobile device of claim 1, wherein the housing defines a first fastener opening and the base defines a second fastener opening, the first and second fastener openings coaxial with each other when the housing is coupled to the base, the first and second fastener openings configured to receive a fastener to secure the housing and a base to the surface.

3. The stand for a mobile device of claim 1, the base defining a cable opening, wherein, when the housing is coupled to the base, the cable opening overlaps with the slot to permit the cable to pass therethrough.

4. The stand for a mobile device of claim 3, wherein the cable opening is adjacent the stop guide, such that, when the housing is rotated relative to the base, the stop guide inhibits the housing from reducing the cable opening.

5. The stand for a mobile device of claim 1, wherein the receptacle is open from a top of the housing, such that a mobile charging device received by the receptacle forms a top surface of the housing.

6. The stand for a mobile device of claim 1, the housing further defining a top surface, wherein the receptacle is underneath the top surface.

7. The stand for a mobile device of claim 6, wherein a thickness of the top surface is about 3 millimeters or less.

8. The stand for a mobile device of claim 6, wherein the top surface is configured to display an advertisement.

9. The stand for a mobile device of claim 1, the housing further defining a cable opening.

10. A stand for a mobile device comprising:
a base;
a housing rotatably coupled to the base, the housing defining:
a receptacle configured to receive a wireless charging device; and
a slot; and
a stop guide protruding from the base into the slot, the stop guide configured to inhibit rotation of the housing relative to the base at a first end of the slot and a second end of the slot.

11. The stand for a mobile device of claim 12, wherein:
the base includes a first coupler; and
the housing includes a second coupler;
wherein the first and second couplers are configured to cooperatively and rotatably secure the housing to the base.

12. The stand for a mobile device of claim 10, the housing further defining a top surface configured to display an advertisement.

13. The stand for a mobile device of claim 10, wherein the top surface defines a retainer configured to receive a removable display sheet configured to display the advertisement.

14. The stand for a mobile device of claim 10, wherein the base defines a cable opening, wherein, when the housing is coupled to the base, the cable opening overlaps with the slot to permit a cable to pass therethrough.

15. The stand for a mobile device of claim 10, the housing further defining a cable recess configured to receive a portion of a cable proximate the wireless charging device when the wireless charging device is received by the receptacle.

16. The stand for a mobile device of claim 10, a top of the housing defines an angle between 1 degrees and 30 degrees relative to the base.

17. The stand for a mobile device of claim 10, the housing comprising:
a housing top half defining the receptacle; and
a housing bottom half defining the slot;
wherein the housing top half and the housing bottom half are configured to be fixed to each other to inhibit separation of the housing top half and the housing bottom half.

18. The stand for a mobile device of claim 10, wherein the slot defines an arc less than 181 degrees, whereby the stop guide and the slot cooperatively confine rotation of the housing relative to the base to the degree of the arc.

19. The stand for a mobile device of claim 10, wherein the base is configured to be secured to a surface by at least one of adhesive, a suction pad, hook and loop fastener, a magnet, or a fastener.

20. A Stand for a mobile device comprising:
a base;
a housing configured to receive a wireless device charger, the housing rotatable relative to the base; and
a stop guide adapted to restrict rotation of the housing relative to the base.
